(19) United States
(12) Patent Application Publication
(10) Pub. No.: US 2013/0120976 A1
(43) Pub. Date: May 16, 2013

(54) Illuminated Shoe Box

(71) Applicant: Jez Milton-John Marston, Arlington, VA (US)

(72) Inventor: Jez Milton-John Marston, Arlington, VA (US)

(21) Appl. No.: 13/356,602

(22) Filed: Jan. 23, 2012

Related U.S. Application Data
(60) Provisional application No. 61/457,176, filed on Jan. 21, 2011.

(51) Int. Cl. F21L 4/02

(52) U.S. Cl. CPC F21L 4/02
USPC 362/155; 362/154

(57) ABSTRACT

An illuminated shoe box is described in which the light emitting means are attached to either one end or both ends of the shoe box to illuminate the majority of the surface of the shoe box. The light emitting means are powered by a power supply device and controlled by a switch control device. The shoe box is made up of semi-transparent/frosted plastic materials and the light emitting means are arranged individually or in a group to provide a uniform illumination of the shoe box, or arranged in a group to form letters and logos.

### REFERENCE TO RELATED APPLICATIONS

This patent application claims the benefit of U.S. Provisional Application No. 61/457,176 filed on Jan. 21, 2011, the disclosure of which is incorporated herein by reference in its entirety.

### BACKGROUND OF THE INVENTION

1. Field of the Invention

The present invention relates to a shoe box having illuminating elements. More particularly, the present invention relates to a shoe box in which the majority of the surface of the shoe box is illuminated in a uniform glow.

Shoe boxes are an important feature when selling shoes. They not only protect the shoes and keep them looking as new as possible until a customer purchases them, but they also showcase and spell out the brand name and logo of the shoe company that produces that shoe. Traditionally, shoe boxes are mainly used for shipping and storing the shoes, and are often consisted of a four sided cardboard structure with a bottom and a cover connected to the four sided structure to form an enclosed container. Typically shoe boxes have been very ordinary and cookie cutter in design and have no other feature than to house the shoes before purchase.

What is desired, therefore, is a shoe box that can not only function as a shipping and storing container of the shoes, but can also create more interest in the shoes and promote the brand name of the shoe manufacturer.

2. Description of Related Art

Some related prior inventions are disclosed as prior art herein. More specifically, by way of example,

U.S. Pat. No. 7,000,762 discloses an illuminated CD jewel box. From the abstract of this patent it is summarized as follows. A compact disc (CD) jewel box is described in which a multifunction light is positioned within the cavity space defined by the CD storage compartment and the CD support tray. The CD jewel box is illuminated with light from one or more light emitting diodes (LEDs) powered by small power supplies or battery cells, using one or more switches that are optionally sensitive to pressure, motion, ambient sound, or light levels. The multifunction light dynamically illuminates the prescribed spaces within the jewel box. A light conducting optical lens is provided to enhance the visual effects by transporting the light as desired.

### SUMMARY OF THE INVENTION

In an exemplary embodiment of the present invention, there is disclosed a shoe box in which the majority of the surface of the box is illuminated in a uniform glow.

Briefly, the present invention implements the light emitting means for illuminating the shoe box by attaching the light emitting means on the interior of the walls of the shoe box, the interior of one or both ends of the shoe box or all ends or walls of the box so that light shines and runs parallel to the box. This will achieve the goal of a uniformly glowing box in which the entire surface will appear to be glowing. The light emitting means may optionally include one or more LED bulbs or other similar light source. The lenses of the LED bulbs or other similar light source are arranged so that they point and shine parallel as well as perpendicular to the surface of the shoe box. The light emitting means is powered by one or more batteries or other similar power supply device. The light emitting means may be turned on or off by a switch control device which may be optionally activated on or off by pressure, by opening/closing the lid or top of the shoe box, or by moving or touching the shoe box. The shape of the shoe box may optionally include, but not be limited to cube, cuboid, cylinder, or other commercially acceptable shapes. The shoe box is to be made up of a semi-transparent/frosted plastic material.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 depicts an illuminated shoe box in accordance to one embodiment of the present invention.

FIG. 2 depicts the illumination of the shoe box turned on in accordance to another embodiment of the present invention.

### DESCRIPTION OF THE PREFERRED EMBODIMENT

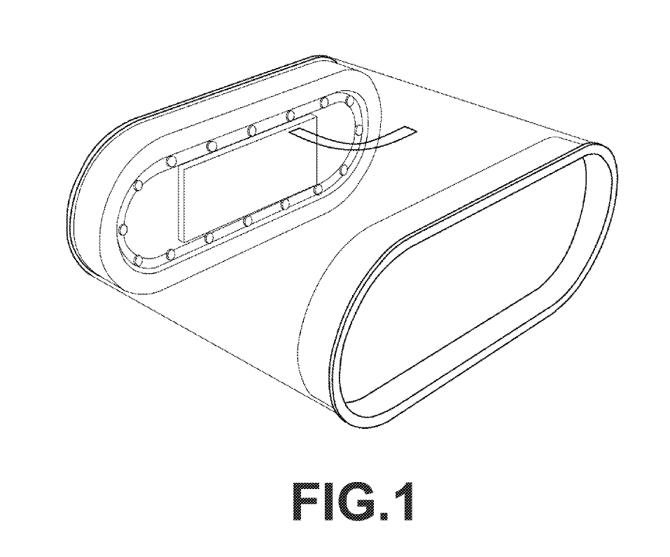

Referring to FIG. 1, there is disclosed an illuminated shoe box comprising of walls 50 and two ends 40 and 60 connected to the wall to form an enclosed container, the light emitting means 10, a power supply device 30 connected to the light emitting means, a switch control device 30 turning on or off the light emitting means.

In the preferred embodiment of the present invention, the shoe box is made up of semi-transparent/frosted plastic materials.

In another preferred embodiment of the present invention, on the interior of the walls, and/or on the interior of one or both ends (40 or 60 in FIG. 1) of the shoe box there are the light emitting means attached that face and point so that the light shines and runs parallel to the box. This will achieve the goal of a uniformly glowing box in which the entire surface will appear to be glowing. In another embodiment of the present invention, the lenses of LED bulbs or other similar light source are arranged so that they point and shine perpendicular to the surface of the box.

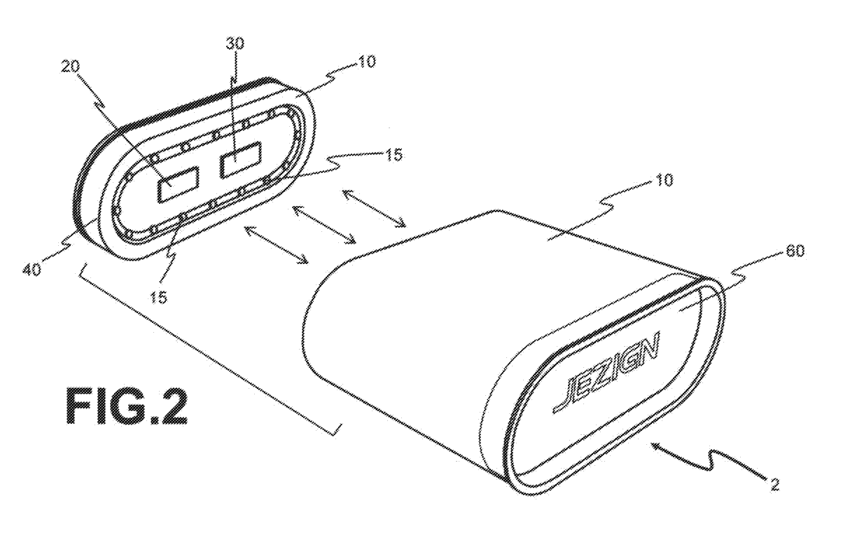

In another preferred embodiment, the light emitting means includes LED bulbs or other similar light sources (15 of FIG. 1). Yet in another preferred embodiment, the LED bulbs or other light sources may be arranged individually or in a group to form letters or logos (as shown in FIG. 2) on the box in addition to the uniform glow. The LED bulbs or other light sources are arranged so that the LED bulbs or other light sources shine through from within the box or are placed on the actual surface of the box itself.

In another preferred embodiment, the light emitting means are turned on or off at the push of a button or switch located on the box. In yet another preferred embodiment, the light emitting means are turned on/off similar to how a refrigerator light is activated. Once the end of the box is opened or removed, the light emitting means would be turned on (as shown in FIG. 2) and once closed turned off. In still another preferred embodiment, the light emitting means are activated by contact. As soon as the box is moved or touched the light emitting means would turn on similar to a touch lamp.

In another preferred embodiment, a sound effect device is included.

When the shoe box is open, the sound effect device and the light emitting means are activated simultaneously.

In another preferred embodiment, a timer is connected to switch control device in which once activated the timer would turn off the light emitting means automatically after a period of time determined.

In another preferred embodiment, the light emitting means are powered by a replaceable battery connected to the light emitting means.

Yet still in another preferred embodiment, a mechanism is used to open the lid/top automatically at the push of a button. Once that button was pushed the lid/top would open on its own (hands free) and trigger the light emitting means turning on as well.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are entitled.

What is claimed is:

1. An illuminated shoe box comprising:
A. a wall with two ends connected to the wall to form an enclosed container;
B. the light emitting means providing illumination of the majority of the surface;
C. a power supply device connected to the light emitting means for supplying electricity to the light emitting means;
D. a switch control device connected to the light emitting means to turn on or off the light emitting means.

2. The illuminated shoe box of claim 1, in which the light emitting means are attached to the interior of walls, and/or the interior of either one or both ends of the shoe box so that the lights shine and run parallel to or perpendicular to the surface of the box.

3. The illuminated shoe box of claim 1, in which the light emitting means are attached to the interior of walls, and/or the interior of either one or both ends of the shoe box so that the lights shine and run parallel to or perpendicular to the surface of the box; and the light emitting means are selected from the group consisting of one or more LED bulbs, other similar light sources, or the combinations of both.

4. The illuminated shoe box of claim 1, in which the light emitting means comprising LED bulbs or other similar light sources are attached to the interior of all of the walls, and/or either one or both ends of the shoe box so that the lights shine and run parallel to or perpendicular to the surface of the box, and are arranged individually, or in a group, or in a group forming letters, words, phrases, logos, images, or the combination of them. The said light emitting means are arranged so that the light emitting means shine through from within the box or are placed on the actual surface of the box itself.

5. The illuminated shoe box of claim 1, in which the light emitting means are powered by one or more batteries.

6. The illuminated shoe box of claim 1, in which the switch control device is activated by
a. pushing a button or a switch; or
b. opening/closing the end(s) of the shoe box; or
c. moving or touching the shoe box.

7. The illuminated shoe box of claim 1, being made up of semi-transparent/frosted plastic materials.

8. The illuminated shoe box of claim 1, in which a timer is connected to the light emitting means to control the duration of illumination.

9. The illuminated shoe box of claim 1, further comprising a sound effect device. When the shoe box is open, the said sound effect device and the light emitting means are activated simultaneously.

10. The illuminated shoe box, comprising
a. a wall and two ends connected to the wall to form an enclosed container which is made up of semi-transparent/frosted plastic materials;
b. the light emitting means comprising LED bulbs or other similar light sources are attached to the interior of the walls, and/or the interior of either one or both ends of the shoe box so that the lights shine and run parallel to or perpendicular to the surface of the box, and are arranged individually, or in a group, or in a group forming letters, words, phrases, logos, images, or the combination of them, and the said light emitting means are arranged to shine through from within the box or are placed on the actual surface of the box itself;
c. a power supply device comprising one or more batteries or other similar power supply connected to the light emitting means;
d. a switch control device that is activated by
1). pushing a button or a switch; or
2). opening/closing the end(s) of the shoe box; or
3) moving or touching the shoe box;

11. The illuminated shoe box of claim 10, further comprising a timer connected to the light emitting means to control the duration of illumination.

12. The illuminated shoe box of claim 10, further comprising a mechanism that automatically opens one end of the shoe box by pushing a button or switch, and simultaneously turn on the light emitting means.

13. The illuminated shoe box of claim 10, further comprising
a. a timer connected to the light emitting means to control the duration of illumination; and
b. a mechanism that automatically opens one end of the shoe box by pushing a button or switch, and simultaneously turn on the light emitting means.

14. The illuminated shoe box of claim 10, further comprising a sound effect device. When the shoe box is open, the said sound effect device and the light emitting means are activated simultaneously.
